(19) United States
(12) Patent Application Publication
(10) Pub. No.: US 2012/0096995 A1
(43) Pub. Date: Apr. 26, 2012

(54) Self-adjusting locking pliers with rear retainer

(76) Inventor: Shin-An Shih, Taichung (TW)

(21) Appl. No.: 12/909,849

(22) Filed: Oct. 22, 2010

(51) Int. Cl. B25B 7/14; B25B 7/12

(52) U.S. Cl. 81/370; 81/372

(57) ABSTRACT

A self-adjusting locking pliers includes a stationary handle; a front stationary jaw; a thumb screw threadedly secured to a rear end of the stationary handle; a front moveable jaw; an operating handle pivotably secured to a rear end of the moveable jaw; a toggle link pivotably interconnecting the stationary handle and the operating handle; a biasing member having one end secured by the moveable jaw and the other end fastened in the stationary handle; a quick release lever having an intermediate portion pivotably fastened in the operating handle and a front end urged against one end of the toggle link in the operating handle; and a retainer having one end pivotably secured to a rear end of the operating handle, the retainer comprising a ring at the other end and a bar interconnecting both ends. The ring may be lockingly put on the thumb screw.

### BACKGROUND OF THE INVENTION

1. Field of Invention

The invention relates to locking pliers and more particularly to a self-adjusting locking pliers having a rear retainer adapted to lockingly engage with a thumb screw for preventing the hand from unintentionally contacting a quick release lever to undesirably unlock the locking pliers in an inoperative position.

2. Description of Related Art

Typically, self-adjusting locking pliers have an open rear end. However, an unintentionally contact of a quick release lever by the hand may trigger a sudden opening of the locked locking pliers. As a result, either an object gripped by jaws may be loosened and dropped onto ground or it may be not an expected act. Both are not desired. Thus, the need for improvement still exists.

### SUMMARY OF THE INVENTION

It is therefore one object of the invention to provide a locking pliers comprising a stationary handle; a front stationary jaw; a thumb screw threadedly secured to a rear end of the stationary handle; a front moveable jaw; an operating handle pivotably secured to a rear end of the moveable jaw; a toggle link pivotably interconnecting the stationary handle and the operating handle; a biasing member having one end secured by the moveable jaw and the other end fastened in the stationary handle; a quick release lever having an intermediate portion pivotably fastened in the operating handle and a front end urged against one end of the toggle link in the operating handle; and a retainer having one end pivotably secured to a rear end of the operating handle, the retainer comprising a ring at the other end and a bar interconnecting both ends, wherein the ring is adapted to lockingly put on the thumb screw in an inoperative position of the locking pliers.

The above and other objects, features and advantages of the invention will become apparent from the following detailed description taken with the accompanying drawings.

### BRIEF DESCRIPTION OF THE DRAWINGS

FIG. 1 is a perspective view of a self-adjusting locking pliers according to a first preferred embodiment of the invention;

FIG. 2 is a side elevation of the self-adjusting locking pliers of FIG. 1 where the retainer is to be engaged with the thumb screw;

FIG. 3 is a view similar to FIG. 2 where the retainer has been lockingly engaged with the thumb screw;

FIG. 4 is a perspective view of a self-adjusting locking pliers according to a second preferred embodiment of the invention;

FIG. 5 is a side elevation of the self-adjusting locking pliers of FIG. 4 where the retainer is to be engaged with the thumb screw;

FIG. 6 is a view similar to FIG. 5 where the retainer has been lockingly engaged with the thumb screw;

FIG. 7 is a perspective view of a self-adjusting locking pliers according to a third preferred embodiment of the invention;

FIG. 8 is a side elevation of the self-adjusting locking pliers of FIG. 1 where the retainer is to be engaged with the thumb screw; and

FIG. 9 is a view similar to FIG. 2 where the retainer has been lockingly engaged with the thumb screw.

### DETAILED DESCRIPTION OF THE INVENTION

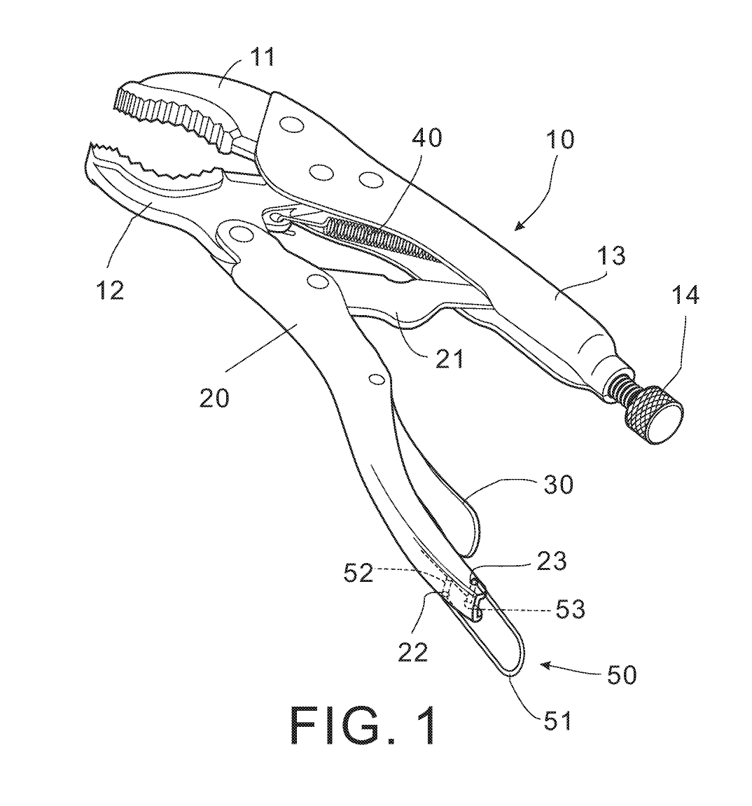

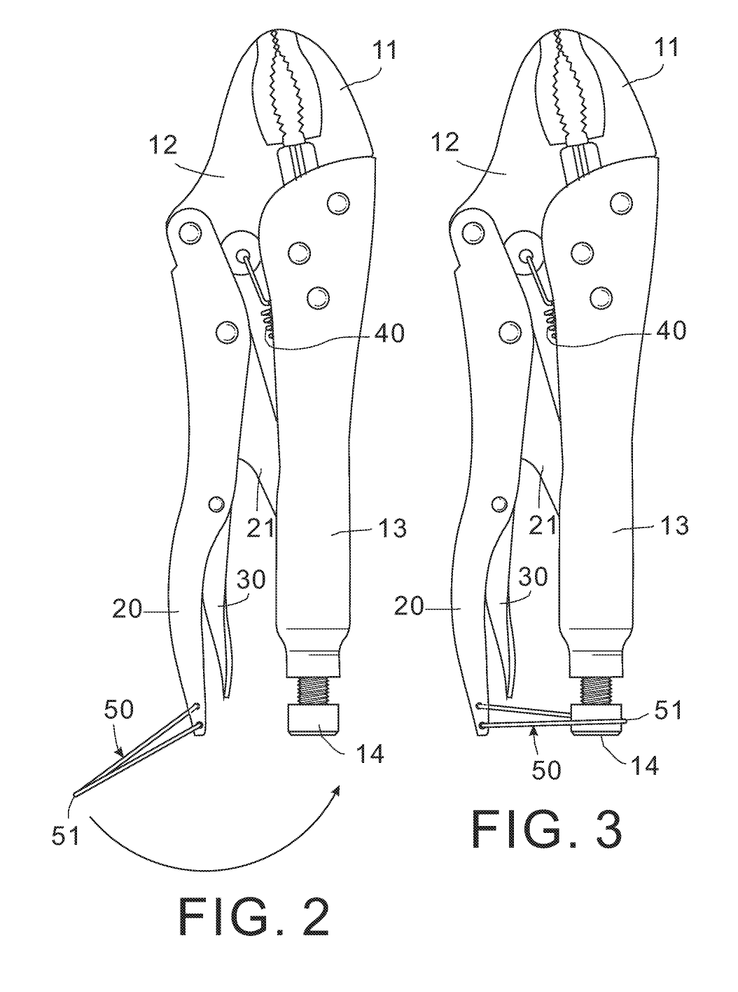

Referring to FIGS. 1 to 3, a self-adjusting locking pliers 10 in accordance with a first preferred embodiment of the invention comprise a stationary handle 13, a front stationary jaw 11, and a thumb screw 14 threadedly secured to a rear end of the stationary handle 13; a front moveable jaw 12, an operating handle 20 pivotably secured to a rear end of the moveable jaw 12, a toggle link 21 pivotably interconnecting the stationary handle 13 and the operating handle 20, and first and second pivot holes 22, 23 on both sides of a U-shaped end of the operating handle 20 respectively; a tension spring 40 having one end secured by the moveable jaw 12 and the other end fastened in the stationary handle 13; a quick release lever 30 having an intermediate portion pivotably fastened in the operating handle 20 and a front end urged against one end of the toggle link 21 in the operating handle 20; and a retainer 50 comprising a substantially U-shaped member 51 having a first pivot pin 52 at a bent end of a long arm and a second pivot pin 53 at a bent end of a short arm. The first pivot pin 52 is pivotably fastened in the first pivot hole 22 and the second pivot pin 53 is pivotably fastened in the second pivot hole 23 respectively.

The first pivot hole 22 is offset with respect to the second pivot hole 23. Compression applied to an object gripped between and by the jaws 11, 12 can be finely adjusted by clockwise or counterclockwise rotating the thumb screw 14.

In an inoperative position of the self-adjusting locking pliers 10, the substantially U-shaped member 51 can be put on the thumb screw 14 to lock a rear end of the self-adjusting locking pliers 10. Thus, an unintentional contact with the quick release lever 30 by the hand to unlock the quick release lever 30 can be prevented from occurring.

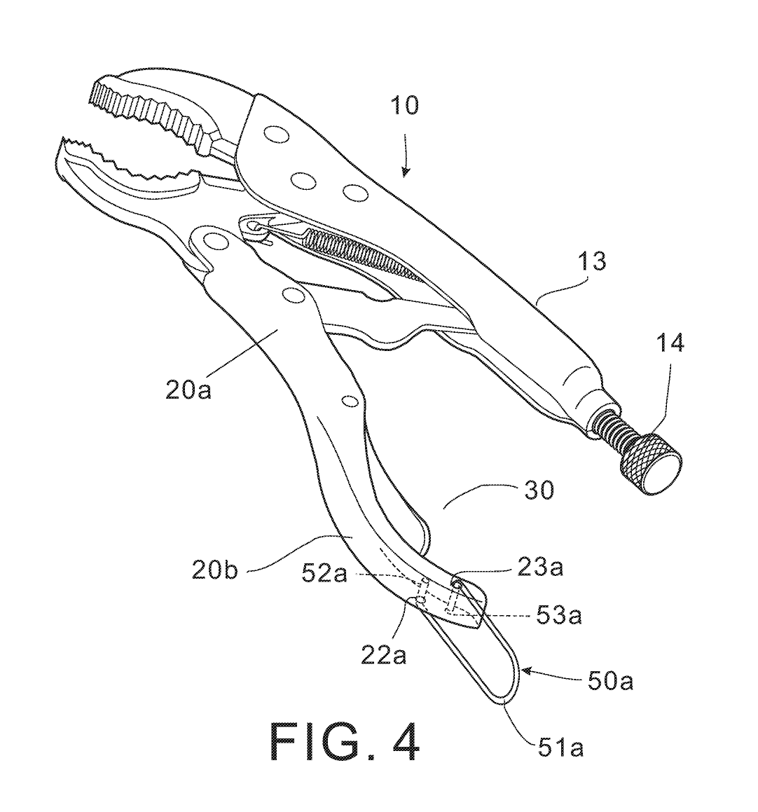

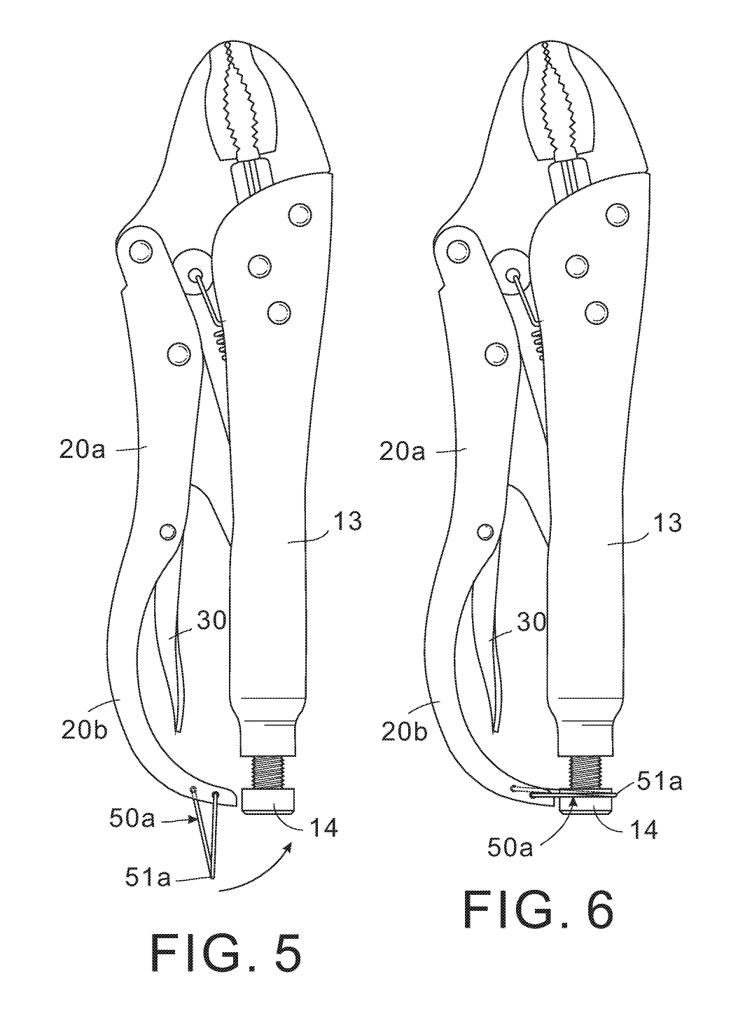

Referring to FIGS. 4 to 6, self-adjusting locking pliers 10 in accordance with a second preferred embodiment of the invention are shown. The characteristics of the second preferred embodiment are substantially the same as that of the first preferred embodiment except the following:

An operating handle 20a has a curved portion 20b extending from the point of the operating handle 20a connecting the quick release lever 30 to its rear end. A retainer 50a comprises a substantially U-shaped member 51a having a first pivot pin 52a at a bent end of a long arm and a second pivot pin 53a at a bent end of a short arm. The first pivot pin 52a is pivotably fastened in a first pivot hole 22a on one side of a U-shaped rear end of the curved portion 20b and the second pivot pin 53a is pivotably fastened in a second pivot hole 23a on the other side of the U-shaped rear end of the curved portion 20b respectively.

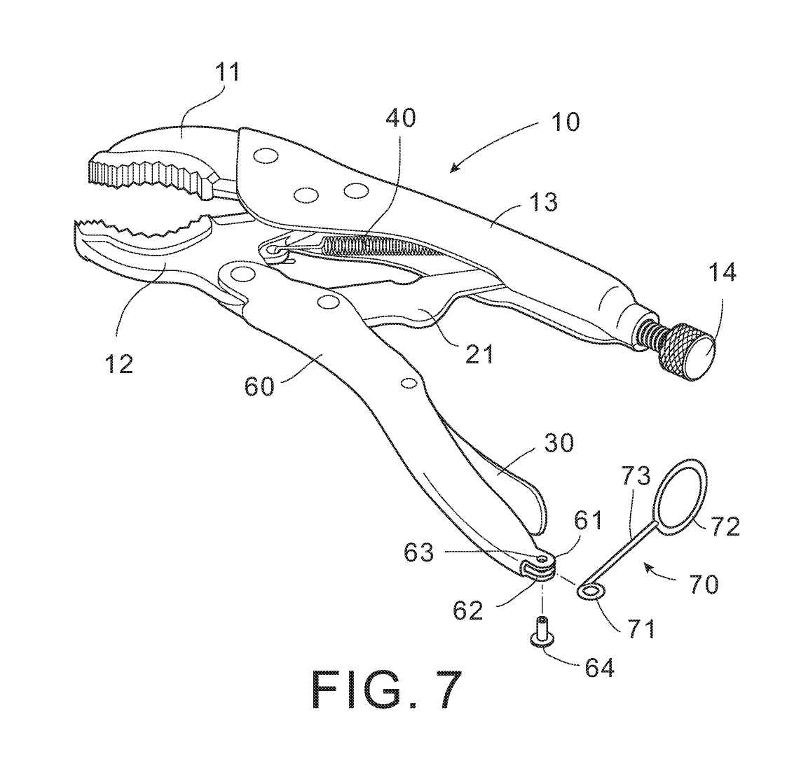

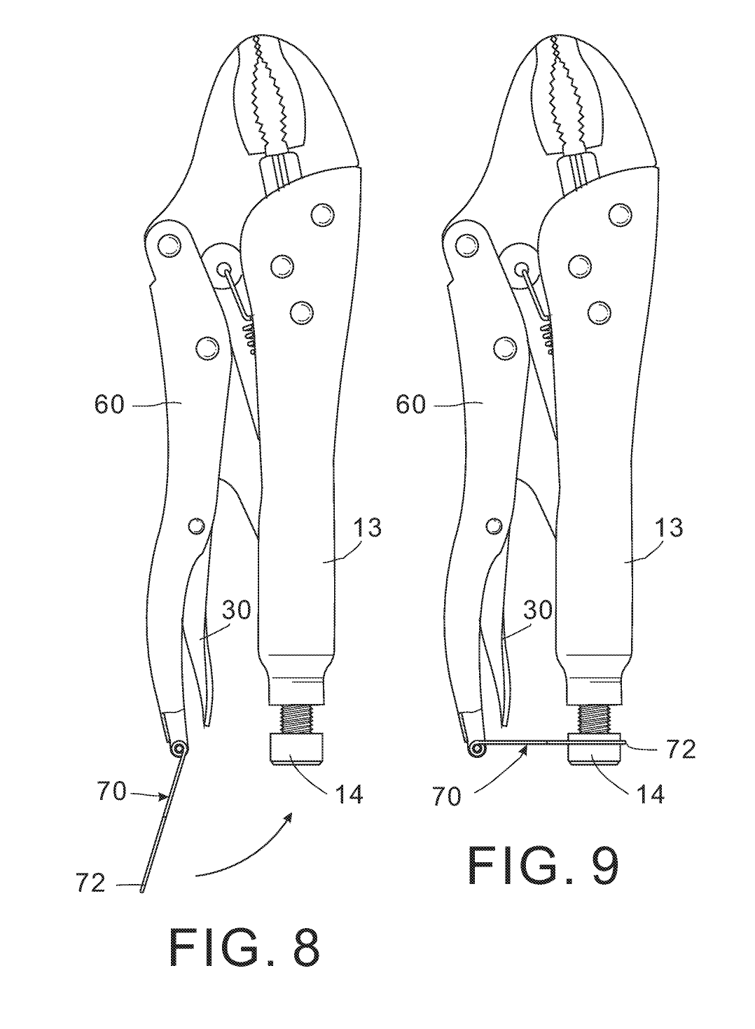

Referring to FIGS. 7 to 9, a self-adjusting locking pliers 10 in accordance with a second preferred embodiment of the invention comprise a stationary handle 13, a front stationary jaw 11, and a thumb screw 14 threadedly secured to a rear end of the stationary handle 13; a front moveable jaw 12, an operating handle 60 pivotably secured to a rear end of the moveable jaw 12, a toggle link 21 pivotably interconnecting the stationary handle 13 and the operating handle 60, and a yoke at a rear end of the operating handle 60 as detailed later; a tension spring 40 having one end secured by the moveable jaw 12 and the other end fastened in the stationary handle 13; a quick release lever 30 having an intermediate portion pivotably fastened in the operating handle 60 and a front end urged against one end of the toggle link 21 in the operating handle 60; and a retainer 70 as detailed later.

Compression applied to an object gripped between and by the jaws 11, 12 can be finely adjusted by clockwise or counterclockwise rotating the thumb screw 14.

The yoke comprises two opposite yoke arms 61, 62 each having a hole 63 therethrough, and a rivet 64. The retainer 70 comprises a small ring 71 at one end, a large ring 72 at the other distal end, and a bar 73 interconnecting the rings 71, 72. The small ring 71 is disposed in a gap between the yoke arms 61, 62. The rivet 64 is driven through one hole 63, the small ring 71, and the other hole 63 to pivotably secure them together.

In an inoperative position of the self-adjusting locking pliers 10, the large ring 72 can be counterclockwise rotated to put on the thumb screw 14 to lock a rear end of the self-adjusting locking pliers 10. Thus, an unintentional contact with the quick release lever 30 by the hand to unlock the quick release lever 30 can be prevented from occurring.

While the invention has been described in terms of preferred embodiments, those skilled in the art will recognize that the invention can be practiced with modifications within the spirit and scope of the appended claims.

What is claimed is:

1. Locking pliers comprising:
a stationary handle;
a front stationary jaw;
a thumb screw threadedly secured to a rear end of the stationary handle;
a front moveable jaw;
an operating handle pivotably secured to a rear end of the moveable jaw;
a toggle link pivotably interconnecting the stationary handle and the operating handle;
a biasing member having one end secured by the moveable jaw and the other end fastened in the stationary handle;
a quick release lever having an intermediate portion pivotably fastened in the operating handle and a front end urged against one end of the toggle link in the operating handle; and
a retainer having one end pivotably secured to a rear end of the operating handle, the retainer comprising a ring at the other end and a bar interconnecting both ends,
wherein the ring is adapted to lockingly put on the thumb screw in an inoperative position of the locking pliers.
